(19) United States
(12) Patent Application Publication
(10) Pub. No.: US 2015/0218422 A1
(43) Pub. Date: Aug. 6, 2015

(54) RESIN FOAM AND FOAM MATERIAL

(71) Applicant: NITTO DENKO CORPORATION, Ibaraki-shi, Osaka (JP)

(72) Inventors: Kazumichi Kato, Ibaraki-shi (JP); Makoto Saitou, Ibaraki-shi (JP); Itsuhiro Hatanaka, Ibaraki-shi (JP); Kiyoaki Kodama, Ibaraki-shi (JP)

(73) Assignee: NITTO DENKO CORPORATION, Ibaraki-shi, Osaka (JP)

(21) Appl. No.: 14/403,822

(22) PCT Filed: May 21, 2013
(86) PCT No.: PCT/JP2013/064041

§ 371 Date: Nov. 25, 2014

(30) Foreign Application Priority Data
May 28, 2012 (JP) 2012-121289
May 17, 2013 (JP) 2013-104989

(51) Int. Cl. C09J 7/02; C09J 133/00; C08J 9/12

(52) U.S. Cl. CPC C09J 7/0289; C08J 9/122; C09J 133/00; C08J 2367/03; C08J 2203/06; C09J 2433/00; C09J 2467/006

(57) ABSTRACT

A resin foam having a repulsive stress when compressed by 80% of 1.0 to 9.0 N/cm², a maximum breaking strength of 1.0 to 10.0 MPa, and a ratio of the maximum breaking strength to a breaking strength in a direction orthogonal to a maximum breaking strength direction (maximum breaking strength/breaking strength in the direction orthogonal to the maximum breaking strength direction) of 1.0 to 5.0. The maximum breaking strength is defined as: a resin foam in a sheet form is measured for a breaking strength in an arbitrary direction in the horizontal direction of the sheet; next, the arbitrary direction is rotated about an axis by 10° intervals to measure a breaking strength in each direction; a direction where the highest breaking strength is measured is defined as the maximum breaking strength direction; and a breaking strength in the maximum breaking strength direction is defined as the maximum breaking strength.

### TECHNICAL FIELD

The present invention relates to a resin foam and a foam material. More specifically, the present invention relates to a resin foam and a foam material used for electric or electronic appliances (for example, cellular phones, personal digital assistants, smart phones, tablet computers (tablet PC), digital cameras, digital video cameras, video cameras, personal computers, and household electrical appliances).

### BACKGROUND ART

Resin foams have excellent cushioning properties and are advantageously used for sealing materials, cushioning materials, pat materials, and the like. For example, polyolefin elastomer foams, urethane elastomer foams, and polyester elastomer foams are used as dustproofing materials, cushioning materials, and the like for liquid crystal displays, plasma displays, organic EL displays, and the like of electric or electronic appliances such as cellular phones and digital cameras.

For example, an uncrosslinked type or crosslinked type polyolefin elastomer foam has been known as a resin foam (refer to Patent Literature 1). Further, a thermoplastic polyester foam suitable for reduction in size, weight, and thickness for electric or electronic appliances has been known (refer to Patent Literature 2).

Furthermore, in recent years, upsizing and reduction in thickness have advanced, and higher dustproofness has been required in mobile computing devices, such as cellular phones. Therefore, a resin foam to be used for such an application is increasingly used under higher compression. However, if the resin foam is hard when it is used under high compression, deformation of a housing and a display may be caused, and the deformation may cause appearance defects, such as color unevenness.

### CITATION LIST

### Patent Literature

Patent Literature 1: Japanese Patent Laid-Open No. 2004-250529

Patent Literature 2: Japanese Patent Laid-Open No. 2008-45120

### SUMMARY OF INVENTION

### Technical Problem

In terms of coping with the change of the shape (for example, reduction in thickness and size, and increase in screen size) or the like of electric or electronic appliances in recent years, characteristics to suppress elongation and tearing in the case of assembly have been increasingly required for resin foams. For example, the width of a portion where a resin foam is used has been reduced with the increase in the screen size of a cellular phone, and the above characteristics have been significantly required for cellular phones.

Further, when a resin foam is assembled, the resin foam is often assembled under a controlled condition (a certain tension) in terms of workability or the like, but if a resin foam is torn, has a different elongation depending on the elongation direction, or shows variation when a force is exerted on the resin foam, the efficiency of assembly may be reduced. Therefore, the resin foam is increasingly demanded for excellent isotropic strength.

Particularly, a resin foam which is flexible under high compression is easily torn, and when such a resin foam is assembled to a housing of an optical member or the like, the resin foam may be unable to be laminated to size.

Therefore, an object of the present invention is to provide a resin foam which can maintain flexibility even under high compression and is excellent in assemblability.

Further, another object of the present invention is to provide a foam material which can maintain flexibility even under high compression and is excellent in assemblability.

### Solution to Problem

Thus, as a result of intensive studies, the present inventors have found that when, in a resin foam, a repulsive stress when the resin foam is compressed by 80% is set within a specific range, and a ratio of a breaking strength in a maximum breaking strength direction (maximum breaking strength) to a breaking strength in the direction orthogonal to a maximum breaking strength direction is set within a specific range, the resin foam can maintain flexibility even under high compression and exhibits excellent assemblability. The present invention has been completed based on these findings.

Specifically, the present invention provides a resin foam having a repulsive stress when compressed by 80% of 1.0 to 9.0 N/cm², a maximum breaking strength as defined below of 1.0 to 10.0 MPa, and a ratio of the maximum breaking strength as defined below to a breaking strength in a direction orthogonal to a maximum breaking strength direction (maximum breaking strength/breaking strength in the direction orthogonal to the maximum breaking strength direction) of 1.0 to 5.0,

wherein the maximum breaking strength is defined as follows: a resin foam in a sheet form is measured for a breaking strength in an arbitrary direction in the horizontal direction of the sheet; next, the arbitrary direction is rotated about an axis by 10° intervals to measure a breaking strength in each direction; a direction where the highest breaking strength is measured is defined as the maximum breaking strength direction; and a breaking strength in the maximum breaking strength direction is defined as the maximum breaking strength.

The resin foam preferably has an average cell diameter of 10 to 200 μm and an apparent density of 0.01 to 0.20 g/cm³.

The resin constituting the resin foam is preferably a thermoplastic resin.

The thermoplastic resin is preferably polyester.

The resin foam is preferably formed through the steps of impregnating a resin composition with a high-pressure gas and subjecting the impregnated resin composition to decompression.

The gas is preferably an inert gas.

The gas is preferably carbon dioxide gas.

The high-pressure gas is preferably a gas in a supercritical state.

The present invention provides a foam material comprising the resin foam.

The foam material preferably has a pressure-sensitive adhesive layer on the resin foam.

The pressure-sensitive adhesive layer is preferably an acrylic pressure-sensitive adhesive layer.

### Advantageous Effects of Invention

The resin foam of the present invention can maintain flexibility even under high compression, and is excellent in assemblability.

Further, since the foam material of the present invention comprises the resin foam, the foam material can maintain flexibility even under high compression, and is excellent in assemblability.

### BRIEF DESCRIPTION OF DRAWINGS

FIG. 1 is a top schematic view showing arbitrary directions in the horizontal direction of a resin foam in a sheet form in which a peel strength was measured for determining a maximum breaking strength and a breaking strength in the direction orthogonal to the maximum breaking strength direction.

FIG. 2 is a sectional schematic view showing a jig used for evaluating housing deformability in which a test piece is set.

### DESCRIPTION OF EMBODIMENTS

The resin foam of the present invention has a repulsive stress when compressed by 80% of 1.0 to 9.0 N/cm², a maximum breaking strength as defined below of 1.0 to 10.0 MPa, and a ratio of the maximum breaking strength as defined below to a breaking strength in a direction orthogonal to a maximum breaking strength direction (maximum breaking strength/breaking strength in the direction orthogonal to the maximum breaking strength direction) of 1.0 to 5.0,

wherein the maximum breaking strength is defined as follows: a resin foam in a sheet form is measured for a breaking strength in an arbitrary direction in the horizontal direction of the sheet; next, the arbitrary direction is rotated about an axis by 10° intervals to measure breaking strength in each direction; a direction where the highest breaking strength is measured is defined as the maximum breaking strength direction; and a breaking strength in the maximum breaking strength direction is defined as the maximum breaking strength.

Note that, in the present specification, the maximum breaking strength defined above may be simply referred to as “maximum breaking strength.”

Further, the “ratio of the maximum breaking strength to a breaking strength in a direction orthogonal to a maximum breaking strength direction (maximum breaking strength/breaking strength in the direction orthogonal to the maximum breaking strength direction)” may be simply referred to as a “strength ratio (maximum breaking strength/breaking strength in the direction orthogonal to the maximum breaking strength direction).”

The resin foam of the present invention is formed by allowing a composition containing at least a resin constituting the resin foam of the present invention (resin composition) to expand. Note that the resin composition preferably contains the resin in an amount of not less than 70% by weight (preferably not less than 80% by weight) relative to the total amount of the resin composition (100% by weight).

The repulsive stress when the resin foam of the present invention is compressed by 80% is 1.0 to 9.0 N/cm², preferably 1.5 to 8.5 N/cm², more preferably 2.0 to 8.0 N/cm². Since the repulsive stresses when compressed by 80% is not less than 1.0 N/cm², the resin foam of the present invention has proper rigidity and good processability. Further, since the repulsive stress when compressed by 80% is not more than 9.0 N/cm², the resin foam of the present invention has excellent flexibility. Since the repulsive stress when compressed by 80% is within the above range, the resin foam of the present invention is rich in flexibility, and even if the resin foam is used for sealing a housing having only a narrow clearance, the housing will not be deformed.

The repulsive stress when compressed by 80% means a compressive stress when a compression ratio is 80%. The compression ratio of 80% means compressing a resin foam in a sheet form to a state where the height of the sheet corresponding to 80% of the initial height is compressed in the thickness direction, that is, a state where the sheet is distorted by 80% from the initial thickness, and the thickness of the resin foam in a sheet form having a compression ratio of 80% corresponds to 20% of the initial thickness.

The maximum breaking strength of the resin foam of the present invention is 1.0 to 10.0 MPa, preferably 1.0 to 8.5 MPa, more preferably 1.2 to 7.5 MPa. Since the maximum breaking strength is not less than 1.0 MPa, the resin foam of the present invention is excellent in strength, and even if a force acts on the resin foam, it will not be easily torn or broken. Further, the resin foam hardly causes plastic deformation. Therefore, the resin foam is excellent in assemblability and processability. Further, since the maximum breaking strength is not more than 10.0 MPa, the resin foam is not hard even under high compression, and is excellent in flexibility even under high compression. Since the resin foam of the present invention has a maximum breaking strength within the above range, even if the resin foam is used for sealing a housing, the resin foam will not cause problems such as tearing and deformation (particularly, plastic deformation) by elongation when assembled to a housing, causing no difficulty in attachment. Note that assemblability means the ease of incorporation when a resin foam is incorporated into a predetermined place by a machine or the hand of a person.

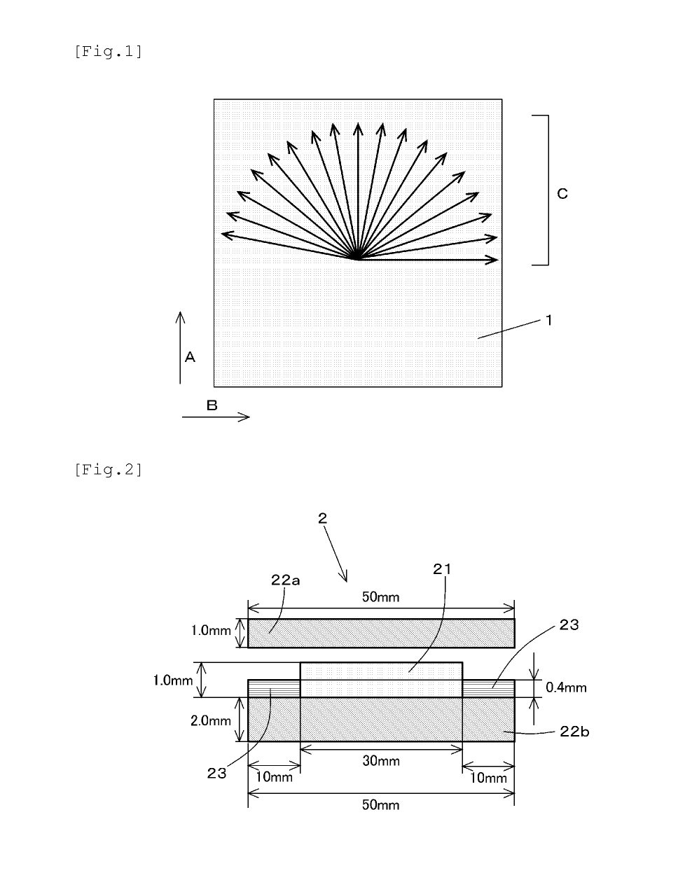

More specifically, the maximum breaking strength is determined as follows. With respect to a resin foam in a sheet form, an arbitrary direction in the horizontal direction (vertical direction to the thickness direction) of the sheet is defined; next, the arbitrary direction is rotated about an axis by 10 degree intervals to thereby define 17 directions (refer to FIG. 1). The breaking strength in the resin foam in a sheet form is measured for each direction of the 18 directions defined as described above, respectively. Then, a direction where the highest breaking strength is measured is defined as the maximum breaking strength direction, and a breaking strength in the maximum breaking strength direction is defined as the maximum breaking strength.

The strength ratio (maximum breaking strength/breaking strength in the direction orthogonal to the maximum breaking strength direction) of the resin foam of the present invention is 1.0 to 5.0, preferably 1.0 to 4.5, more preferably 1.0 to 4.0. Since the strength ratio (maximum breaking strength/breaking strength in the direction orthogonal to the maximum breaking strength direction) is within the above range, the resin foam of the present invention is not extremely weak only in a specific direction, and is excellent in attaching accuracy. Therefore, the resin foam is excellent in assemblability. Note that if the strength ratio (maximum breaking strength/breaking strength in the direction orthogonal to the maximum breaking strength direction) more than 5.0, the anisotropy of the strength in the horizontal direction (vertical direction to the thickness direction) of the resin foam in a sheet form will be increased, and the resin foam will be easily cut even when the resin foam has a high strength. For example, when the resin foam is assembled under the application of a predetermined tension, a variation in elongation will be increased to reduce accuracy, and in some cases, tearing, rupture, and breaking may occur.

The breaking strength is determined based on the section of tensile strength and elongation in JIS K 6767.

Note that when the resin foam of the present invention has a shape in a sheet form or a tape form, and when a longitudinal direction (MD direction, machine direction) is the maximum breaking strength direction, the direction orthogonal to the maximum breaking strength direction is a width direction (TD direction). On the other hand, when a width direction is the maximum breaking strength direction, the direction orthogonal to the maximum breaking strength direction is a longitudinal direction.

The average cell diameter of the resin foam of the present invention is preferably 10 to 200 μm, more preferably 15 to 150 μm, further preferably 20 to 100 μm, but is not particularly limited thereto. In the resin foam of the present invention, the average cell diameter is preferably not less than 10 μm because excellent flexibility can be easily obtained. Further, the average cell diameter is preferably not more than 200 μm because occurrence of pinholes can be suppressed, and excellent sealing properties and excellent dustproofness are easily obtained.

The cell diameter in the cell structure of the resin foam of the present invention can be determined, for example, by capturing an enlarged image of a cell-structure portion in a cut surface with a digital microscope, determining the area of the cells, and converting it to the equivalent circle diameter.

Note that the resin foam of the present invention preferably has a uniform and micro cell structure in terms of flexibility, sealing properties, and dustproofness. Further, the resin foam preferably does not contain coarse cells (particularly, cells having a cell diameter of more than 300 μm).

The cell structure of the resin foam of the present invention is preferably a semi-open/semi-closed cell structure in terms of strength, sealing properties, dustproofness, and flexibility, but is not particularly limited thereto. The semi-open/semi-closed cell structure is a cell structure containing both a closed cell moiety and an open cell moiety, and the ratio between the closed cell moiety and the open cell moiety is not particularly limited. A cell structure in which a closed-cell moiety occupies not more than 40% (preferably not more than 30%) of the resin foam is particularly preferred.

The apparent density of the resin foam of the present invention is preferably 0.01 to 0.20 g/cm³, more preferably 0.01 to 0.15 g/cm³, but is not particularly limited thereto. The resin foam of the present invention preferably has a density of not less than 0.01 g/cm³ because satisfactory strength can be obtained. Further, the resin foam of the present invention preferably has a density of not more than 0.20 g/cm³ because the resin foam has a high expansion ratio and can obtain excellent flexibility. That is, when the resin foam of the present invention has an apparent density of 0.01 to 0.20 g/cm³, the resin foam will obtain better foaming characteristics (high expansion ratio) and easily exhibit proper strength, excellent flexibility, and excellent cushioning properties.

Particularly, the resin foam of the present invention preferably has an average cell diameter of 10 to 200 μm and an apparent density of 0.01 to 0.20 g/cm³ in terms of obtaining a high expansion ratio while obtaining proper strength, thus obtaining excellent flexibility and excellent sealing properties and dustproofness.

The shape of the resin foam of the present invention is preferably a sheet form and a tape form, but is not particularly limited thereto. Further, the resin foam may also be processed into a suitable shape depending on the purpose of use. For example, it may also be processed into a linear shape, a round shape, a polygonal shape, or a frame shape (framed shape) by cutting, punching, or the like.

The thickness of the resin foam of the present invention is preferably 0.05 to 3.0 mm, more preferably 0.06 to 2.8 mm, further preferably 0.07 to 1.5 mm, particularly preferably 0.08 to 1.0 mm, but is not particularly limited thereto.

The resin which is a material of the resin foam of the present invention preferably includes a thermoplastic resin, but is not particularly limited thereto. The resin foam of the present invention may comprise one resin or may comprise not less than two resins.

Examples of the thermoplastic resin include polyolefinic resins such as low density polyethylene, medium density polyethylene, high density polyethylene, linear low density polyethylene, polypropylene, a copolymer of ethylene and propylene, a copolymer of ethylene or propylene with other α-olefins (such as butene-1, pentene-1, hexene-1, and 4-methylpentene-1), a copolymer of ethylene and other ethylenic unsaturated monomers (such as vinyl acetate, acrylic acid, acrylate, methacrylic acid, methacrylate, and vinyl alcohol); styrenic resins such as polystyrene and an acrylonitrile-butadiene-styrene copolymer (ABS resin); polyamide resins such as 6-nylon, 66-nylon, and 12-nylon; polyamideimide; polyurethane; polyimide; polyether imide; acrylic resins such as polymethylmethacrylate; polyvinyl chloride; polyvinyl fluoride; alkenyl aromatic resin; polyester resins such as polyethylene terephthalate and polybutylene terephthalate; polycarbonate such as bisphenol A polycarbonate; polyacetal; and polyphenylene sulfide. Further, the thermoplastic resin may be used alone or in combination. Note that when the thermoplastic resin is a copolymer, it may be a copolymer in the form of a random copolymer or a block copolymer.

The thermoplastic resin also includes a rubber component and/or a thermoplastic elastomer component. The rubber component and thermoplastic elastomer component have a glass transition temperature of equal to or lower than room temperature (for example, not more than 20° C.), and therefore, when the component is formed into a resin foam, the resulting foam is significantly excellent in flexibility and shape conformability. Note that the resin foam of the present invention may be formed from a resin composition containing the thermoplastic resin and a rubber component and/or a thermoplastic elastomer component.

The rubber component or thermoplastic elastomer component is not particularly limited as long as it has rubber elasticity and can be expanded, and examples thereof include various thermoplastic elastomers such as natural or synthetic rubber such as natural rubber, polyisobutylene, polyisoprene, chloroprene rubber, butyl rubber, and nitrile butyl rubber; olefinic elastomers such as ethylene-propylene copolymers, ethylene-propylene-diene copolymers, ethylene-vinylacetate copolymers, polybutene, and chlorinated polyethylene; styrenic elastomers such as styrene-butadiene-styrene copolymers, styrene-isoprene-styrene copolymers, and hydrogenated polymers derived from them; polyester elastomers; polyamide elastomers; and polyurethane elastomers. Note that these rubber components and/or thermoplastic elastomer components may be used alone or in combination.

The thermoplastic resin is preferably polyester (polyester such as the polyester resin and the polyester elastomer as described above), more preferably a polyester elastomer, in terms of obtaining a repulsive stress when compressed by 80% within a specific range, a maximum breaking strength within a specific range, and a strength ratio (maximum breaking strength/breaking strength in the direction orthogonal to the maximum breaking strength direction) within a specific range, thereby maintaining flexibility even under high compression and obtaining excellent assemblability. That is, the resin foam of the present invention is more preferably a resin foam formed from a resin composition containing a polyester elastomer (polyester elastomer foam).

The polyester elastomer is not particularly limited as long as it is a resin having an ester binding site derived from a reaction (polycondensation) of a polyol component with a polycarboxylic acid component. Examples of the polyester elastomer include a polyester thermoplastic resin obtained by polycondensation of an aromatic dicarboxylic acid (divalent aromatic carboxylic acid) with a diol component.

Examples of the aromatic dicarboxylic acid include terephthalic acid, isophthalic acid, phthalic acid, naphthalene carboxylic acid (such as 2,6-naphthalene dicarboxylic acid, 1,4-naphthalene dicarboxylic acid), diphenyl ether dicarboxylic acid, and 4,4-biphenyl dicarboxylic acid. Note that the aromatic dicarboxylic acid may be used alone or in combination.

Further, examples of the diol component include aliphatic diols such as ethylene glycol, propylene glycol, trimethylene glycol, 1,4-butanediol (tetramethylene glycol), 2-methyl-1,3-propanediol, 1,5-pentanediol, 2,2-dimethyl-1,3-propanediol (neopentyl glycol), 1,6-hexanediol, 3-methyl-1,5-pentanediol, 2-methyl-2,4-pentanediol, 1,7-heptane diol, 2,2-diethyl-1,3-propanediol, 2-methyl-2-propyl-1,3-propanediol, 2-methyl-1,6-hexanediol, 1,8-octanediol, 2-butyl-2-ethyl-1,3-propanediol, 1,3,5-trimethyl-1,3-pentanediol, 1,9-nonanediol, 2,4-diethyl-1,5-pentanediol, 2-methyl-1,8-octanediol, 1,10-decanediol, 2-methyl-1,9-nonanediol, 1,18-octadecanediol, and dimer diol; alicyclic diols such as 1,4-cyclohexanediol, 1,3-cyclohexanediol, 1,2-cyclohexanediol, 1,4-cyclohexanedimethanol, 1,3-cyclohexanedimethanol, and 1,2-cyclohexanedimethanol; aromatic diols such as bisphenol A, an ethylene oxide adduct of bisphenol A, bisphenol S, an ethylene oxide adduct of bisphenol S, xylylene diol, and naphthalenediol; ether glycols such as diethylene glycol, triethylene glycol, tetraethylene glycol, polyethylene glycol, and dipropylene glycol. Note that the diol component may be a diol component in a polymer form such as a polyether diol and a polyester diol. Examples of the polyetherdiols include polyethylene glycol, polypropylene glycol, and polytetramethylene glycol obtained by ring opening polymerization of ethylene oxide, propylene oxide, and tetrahydrofuran, respectively, and polyetherdiols such as copolyethers obtained by copolymerization of these monomers. Further, the diol component may be used alone or in combination.

Examples of the polyester thermoplastic resin include polyalkylene terephthalate resins such as polyethylene terephthalate, polytrimethylene terephthalate, polybutylene terephthalate, polyethylene naphthalate, polybutylene naphthalate, and polycyclohexane terephthalate. Other examples of the polyester thermoplastic resin also includes a copolymer obtained by copolymerizing two or more of the polyalkylene terephthalate resins. Note that when the polyalkylene terephthalate resin is a copolymer, it may be a copolymer in the form of a random copolymer, a block copolymer, or a graft copolymer.

Further, examples of a polyester elastomer include a polyester elastomer which is a block copolymer of a hard segment and a soft segment.

Examples of such a polyester elastomer (polyester elastomer which is a block copolymer of a hard segment and a soft segment) include (i) a polyester-polyester type copolymer containing, as a hard segment, a polyester formed by polycondensation of the aromatic dicarboxylic acid with a diol component having 2 to 4 carbon atoms between the hydroxyl groups in the main chain among the diol components and containing, as a soft segment, a polyester formed by polycondensation of the aromatic dicarboxylic acid with a diol component having 5 or more carbon atoms between the hydroxyl groups in the main chain among the diol components; (ii) a polyester-polyether type copolymer containing the same polyester as in the above (i) as a hard segment and containing a polyether such as the above polyetherdiols as a soft segment; and (iii) a polyester-polyester type copolymer containing the same polyester as in the above (i) and (ii) as a hard segment and containing an aliphatic polyester as a soft segment.

Particularly, when the resin foam of the present invention is a polyester elastomer foam, the polyester elastomer constituting the foam is preferably a polyester elastomer which is a block copolymer of a hard segment and a soft segment, more preferably the above (ii) polyester-polyether type copolymer (a polyester-polyether type copolymer containing, as a hard segment, a polyester formed by polycondensation of an aromatic dicarboxylic acid with a diol component having 2 to 4 carbon atoms between the hydroxyl groups in the main chain, and containing a polyether as a soft segment).

More specific examples of the above (ii) polyester-polyether type copolymer include a polyester-polyether type block copolymer having polybutylene terephthalate as a hard segment and a polyether as a soft segment.

The melt flow rate (MFR) at 230° C. of a resin constituting the resin foam of the present invention is preferably 1.5 to 4.0 g/10 min, more preferably 1.5 to 3.8 g/10 min, further preferably 1.5 to 3.5 g/10 min, but is not particularly limited thereto. The melt flow rate (MFR) at 230° C. of the resin is preferably not less than 1.5 g/10 min because the moldability of the resin composition used for forming the resin foam of the present invention is improved. Further, the melt flow rate (MFR) at 230° C. of the resin is preferably not more than 4.0 g/10 min because the variation in the cell diameter hardly occurs after the formation of a cell structure, and a uniform cell structure is easily obtained. Note that, in the present specification, the MFR at 230° C. refers to an MFR measured at a temperature of 230° C. and a load of 2.16 kgf based on ISO1133 (JIS K 7210).

That is, the resin foam of the present invention is preferably formed from a resin composition containing a resin having a melt flow rate (MFR) at 230° C. of 1.5 to 4.0 g/10 min. Particularly, when the resin foam of the present invention is a polyester elastomer foam, the resin foam is preferably formed from a resin composition containing a polyester elastomer (particularly, a polyester elastomer which is a block copolymer of a hard segment and a soft segment) having a melt flow rate (MFR) at 230° C. of 1.5 to 4.0 g/10 min.

The resin composition forming the resin foam of the present invention preferably contains a foam nucleating agent in addition to the resin as described above. When the resin composition contains a foam nucleating agent, a resin foam in a good foamed state can be easily obtained. Note that the foam nucleating agent may be used alone or in combination.

The foam nucleating agent preferably includes an inorganic substance, but is not particularly limited thereto. Examples of the inorganic substance include hydroxides such as aluminum hydroxide, potassium hydroxide, calcium hydroxide, and magnesium hydroxide; clay (particularly hard clay); talc; silica; zeolite; alkaline earth metal carbonates such as calcium carbonate and magnesium carbonate; metal oxides such as zinc oxide, titanium oxide, and alumina; metal powder such as various metal powder such as iron powder, copper powder, aluminum powder, nickel powder, zinc powder, and titanium powder, and alloy powder; mica; carbon particles; glass fiber; carbon tubes; laminar silicates; and glass.

Especially, as an inorganic substance as a foam nucleating agent, clay and alkaline earth metal carbonates are preferred, and hard clay is more preferred, in terms of suppressing the occurrence of coarse cells and capable of easily obtaining a uniform and micro cell structure.

The hard clay is clay containing substantially no coarse particles. In particular, the hard clay is preferably clay having a residue on a 166 mesh sieve of not more than 0.01%, and more preferably clay having a residue on a 166 mesh sieve of not more than 0.001%. Note that the residue on sieve refers to the proportion (based on weight) of particles remaining on a sieve without passing through it when the particles are sieved to the total particles.

The hard clay includes aluminum oxide and silicon oxide as essential components. The proportion of the sum of the aluminum oxide and the silicon oxide in the hard clay is preferably not less than 80% by weight (for example, 80 to 100% by weight), more preferably not less than 90% by weight (for example, 90 to 100% by weight) relative to the total amount (100% by weight) of the hard clay. Further, the hard clay may be fired.

The average particle size of the hard clay is preferably 0.1 to 10 μm, more preferably 0.2 to 5.0 μm, further preferably 0.5 to 1.0 μm, but is not limited thereto.

Further, the inorganic substance is preferably subjected to surface treatment. That is, the foam nucleating agent is preferably a surface-treated inorganic substance. Examples of surface treatment agents used for the surface treatment of the inorganic substance preferably include, but are not particularly limited to, aluminum compounds, silane compounds, titanate compounds, epoxy compounds, isocyanate compounds, higher fatty acids or salts thereof, and phosphoric esters, more preferably include silane compounds (particularly, silane coupling agents) and higher fatty acids or salts thereof (particularly, stearic acid), in terms of obtaining such an effect that application of surface treatment improves compatibility with a resin (particularly, polyester) to thereby prevent occurrence of voids during expansion, molding, kneading, drawing, or the like or prevent rupture of cells during expansion. Note that the surface treatment agent may be used alone or in combination.

That is, it is particularly preferred that the surface treatment of the inorganic substance be silane coupling treatment or treatment with a higher fatty acid or a salt thereof.

The aluminum compound is preferably, but not limited to, an aluminate coupling agent. Examples of the aluminate coupling agent include acetoalkoxy aluminum diisopropylate, aluminum ethylate, aluminum isopropylate, mono-sec-butoxy aluminum diisopropylate, aluminum secbutyrate, ethyl acetoacetate aluminum diisopropylate, aluminum tris(ethyl acetoacetate), aluminum mono-acetylacetonate bis(ethyl acetoacetate), aluminum tris(acetylacetonate), a cyclic aluminum oxide isopropylate, and a cyclic aluminum oxide isostearate.

The silane compound is preferably, but not limited to, a silane coupling agent. Examples of the silane coupling agent include a vinyl group-containing silane coupling agent, a (meth)acryloyl group-containing silane coupling agent, an amino group-containing silane coupling agent, an epoxy group-containing silane coupling agent, a mercapto group-containing silane coupling agent, a carboxyl group-containing silane coupling agent, and a halogen atom-containing silane coupling agent. Specific examples of the silane coupling agent include vinyltrimethoxysilane, vinylethoxysilane, dimethylvinylmethoxysilane, dimethylvinylethoxysilane, methylvinyldimethoxysilane, methylvinyldiethoxysilane, vinyl-tris(2-methoxy)silane, vinyltriacetoxysilane, 2-methacryloxyethyltriethoxysilane, 3-methacryloxypropyltrimethoxysilane, 3-methacryloxypropyltriethoxysilane, 3-methacryloxypropylmethyldimethoxysilane, 3-aminopropyltrimethoxysilane, 3-aminopropyltriethoxysilane, 2-aminoethyltrimethoxysilane, 3-[N-(2-aminoethyl)amino]propyltrimethoxysilane, 3-[N-(2-aminoethyl)amino]propyltriethoxysilane, 2-[N-(2-aminoethyl)amino]ethyltrimethoxysilane, 2-(3,4-epoxycyclohexyl)ethyltrimethoxysilane, 2-(3,4-epoxycyclohexyl)ethyltriethoxysilane, 3-glycidoxypropyltrimethoxysilane, 3-glycidoxypropylmethyldiethoxysliane, 2-glycidoxyethyltriethoxysilane, glycidoxyethyltrimethoxysilane, 2-glycidoxyethyltriethoxysilane, 3-mercaptopropyltrimethoxysilane, carboxymethyltriethoxysilane, 3-carboxyprpopyltrimethoxysilane, and 3-carboxypropyltriethoxysilane.

The titanate compound is preferably, but not limited to, a titanate coupling agent. Examples of the titanate coupling agent include isopropyl triisostearoyl titanate, isopropyl tris(dioctylpyrophosphate)titanate, isopropyl tri(N-aminoethyl-aminoethyl)titanate, isopropyl tridecylbenzenesulphonyl titanate, tetraisopropyl bis(dioctylphosphite)titanate, tetraoctyl bis(ditridecylphosphite)titanate, tetra(2,2-diallyloxymethyl-1-butyl)bis(di-tridecyl)phosphite titanate, bis(dioctylpyrophosphate)oxyacetate titanate, bis(dioctylpyrophosphate)ethylene titanate, isopropyl trioctanoyl titanate, isopropyl dimethacryl isostearoyl titanate, isopropyl isostearoyl diacryl titanate, isopropyl tri(dioctylphosphate)titanate, isopropyl tricumylphenyl titanate, dicumylphenyloxyacetate titanate, and diisostearoylethylene titanate.

The epoxy compound is preferably, but not limited to, an epoxy resin and a mono-epoxy compound. Examples of the epoxy resin include a glycidyl ether type epoxy resin such as a bisphenol A type epoxy resin, a glycidyl ester type epoxy resin, a glycidyl amine type epoxy resin, and an alicyclic epoxy resin. Further, examples of the mono-epoxy compound include styrene oxide, glycidyl phenyl ether, allyl glycidyl ether, glycidyl(meth)acrylate, 1,2-epoxycyclohexane, epichlorohydrin, and glycidol.

The isocyanate compound is preferably, but not limited to, a polyisocyanate compound and a monoisocyanate compound. Examples of the polyisocyanate compound include an aliphatic diisocyanate such as tetramethylene diisocyanate and hexamethylene diisocyanate; an alicyclic diisocyanate such as isophorone diisocyanate and 4,4′-dicyclohexylmethane diisocyanate; an aromatic diisocyanate such as diphenylmethane diisocyanate, 2,4-tolylene diisocyanate, 2,6-tolylene diisocyanate, phenylene diisocyanate, 1,5-naphthylene diisocyanate, xylylene diisocyanate, and toluylene diisocyanate; and a polymer having a free isocyanate group derived from a reaction of the above diisocyanate compound with a polyol compound. Further, examples of the monoisocyanate compound include phenyl isocyanate and stearyl isocyanate.

Examples of the higher fatty acid or a salt thereof include a higher fatty acid such as oleic acid, stearic acid, palmitic acid, and lauric acid, and a salt (for example, a metal salt and the like) of the higher fatty acid. Examples of the metal atom in the metal salt of the higher fatty acid include an alkali metal atom such as a sodium atom and a potassium atom and an alkali earth metal atom such as a magnesium atom and a calcium atom.

The phosphoric acid esters are preferably phosphoric acid partial esters. Examples of the phosphoric acid partial esters include a phosphoric acid partial ester in which phosphoric acid (orthophosphoric acid or the like) is partially esterified (mono- or di-esterified) with an alcohol component (stearyl alcohol or the like) and a salt (such as a metal salt with an alkali metal or the like) of the phosphoric acid partial ester.

Examples of the process for the surface treatment of the inorganic substances with the surface treatment agent include, but are not limited to, a dry process, a wet process, and an integral blending process. Further, the amount of the surface treatment agent in the surface treatment of the inorganic substance with the surface treatment agent is preferably 0.1 to 10 parts by weight, more preferably 0.3 to 8 parts by weight relative to 100 parts by weight of the above inorganic substance, but is not limited thereto.

Further, the residue on a 166 mesh sieve of the inorganic substance is preferably not more than 0.01%, more preferably not more than 0.001%, but is not limited thereto. This is because if coarse particles are present when a resin composition is allowed to expand, the rupture of cells can easily occur. This is because the size of the particles exceeds the thickness of the cell wall.

The average particle size of the inorganic substance is preferably 0.1 to 10 μm, more preferably 0.2 to 5.0 μm, further preferably 0.5 to 1.0 μm, but is not limited thereto. If the average particle size is less than 0.1 μm, the inorganic substance may not sufficiently function as a nucleating agent. On the other hand, if the average particle size exceeds 10 μm, it may cause outgassing during foaming of a resin composition. Therefore, these average particle sizes are not preferred.

Particularly, the foam nucleating agent is preferably a surface-treated inorganic substance (particularly, a surface-treated hard clay), in terms of compatibility with a resin and capable of easily obtaining a micro cell structure by suppressing the foam rupture during foaming due to the occurrence of voids at the interface between a resin and an inorganic substance.

The content of the foam nucleating agent in the resin composition is preferably 0.1 to 20% by weight, more preferably 0.1 to 10% by weight, further preferably 0.3 to 6% by weight, relative to the total amount (100% by weight) of the resin composition, but is not limited thereto. The content is preferably not less than 0.1% by weight because the occurrence of coarse cells is prevented, and a resin foam having a uniform and micro cell structure is easily obtained. Further, the content is preferably not more than 20% by weight because a significant increase in the viscosity of a resin composition can be suppressed; outgassing during the foaming of a resin composition can be suppressed; and a uniform cell structure is easily obtained.

Further, the resin composition preferably contains an epoxy-modified polymer. The epoxy-modified polymer acts as a crosslinking agent. It also acts as a modifier (resin modifier) for improving the melt tension and the degree of strain hardening of a resin composition (particularly, a resin composition containing a polyester elastomer). Therefore, the resin composition preferably contains the epoxy-modified polymer because of obtaining a repulsive stress when compressed by 80% within a specific range, a maximum breaking strength within a specific range, and a strength ratio (maximum breaking strength/breaking strength in the direction orthogonal to the maximum breaking strength direction) within a specific range, thereby maintaining flexibility even under high compression and capable of easily obtaining excellent assemblability. A highly-expanded micro cell structure is also easily obtained. Note that an epoxy-modified polymer may be used alone or in combination.

The epoxy-modified polymer is preferably, but not particularly limited to, at least one polymer selected from an epoxy-modified acrylic polymer which is a polymer having an epoxy group in a terminal of the main chain and a side chain of an acrylic polymer and an epoxy-modified polyethylene which is a polymer having an epoxy group in a terminal of the main chain and a side chain of polyethylene, in terms of hardly forming a three-dimensional network as compared with a low molecular weight compound having an epoxy group and capable of easily obtaining a resin composition (particularly, a resin composition containing a polyester elastomer) excellent in melt tension and the degree of strain hardening.

The weight average molecular weight of the epoxy-modified polymer is preferably 5,000 to 10,000, more preferably 8,000 to 80,000, further preferably 10,000 to 60,000, particularly preferably 20,000 to 60,000, but is not particularly limited thereto. Note that if the molecular weight is less than 5,000, the reactivity of the epoxy-modified polymer may increase, and a resin composition may not be highly expanded.

The epoxy equivalent of the epoxy-modified polymer is preferably 100 to 3000 g/eq, more preferably 200 to 2500 g/eq, further preferably 300 to 2000 g/eq, particularly preferably 800 to 1600 g/eq, but is not particularly limited thereto. The epoxy equivalent of the epoxy-modified polymer is preferably not more than 3000 g/eq because the melt tension and the degree of strain hardening of a resin composition (particularly, a resin composition containing a polyester elastomer) can be sufficiently improved to obtain a maximum breaking strength within a specific range and a strength ratio (maximum breaking strength/breaking strength in the direction orthogonal to the maximum breaking strength direction) within a specific range, and thereby, assemblability is easily improved and a highly-expanded micro cell structure is easily obtained. Further, the epoxy equivalent of the epoxy-modified polymer is preferably not less than 100 g/eq because this can suppress a problem that the reactivity of the epoxy-modified polymer is increased to excessively increase the viscosity of the resin composition to prevent the resin composition from being highly expanded.

The viscosity (B type viscosity, 25° C.) of the epoxy-modified polymer is preferably 2000 to 4000 mPa·s, more preferably 2500 to 3200 mPa·s, but is not particularly limited thereto. The viscosity of the epoxy-modified polymer is preferably not less than 2000 mPa·s because the failure of the cell wall during foaming of a resin composition is suppressed, and a highly-expanded micro cell structure is easily obtained. On the other hand, the viscosity is preferably not more than 4000 mPa·s because the fluidity of the resin composition is easily obtained, and the resin composition can be efficiently expanded.

Particularly, the epoxy-modified polymer preferably has a weight average molecular weight of 5,000 to 10,000 and an epoxy equivalent of 100 to 3000 g/eq.

The content of the epoxy-modified polymer in the resin composition is preferably 0.5 to 15.0 parts by weight, more preferably 0.6 to 10.0 parts by weight, further preferably 0.7 to 7.0 parts by weight, particularly preferably 0.8 to 3.0 parts by weight, relative to 100 parts by weight of the resin in the resin composition, but is not particularly limited thereto. The content of the epoxy-modified polymer is preferably not less than 0.5 parts by weight because the melt tension and the degree of strain hardening of a resin composition can be increased, and the melt tension and the degree of strain hardening of a resin composition (particularly, a resin composition containing a polyester elastomer) can be sufficiently improved to obtain a maximum breaking strength within a specific range and a strength ratio (maximum breaking strength/breaking strength in the direction orthogonal to the maximum breaking strength direction) within a specific range, and thereby, assemblability is easily improved and a highly-expanded micro cell structure is easily obtained. Further, the content of the epoxy-modified polymer is preferably not more than 15.0 parts by weight because this can suppress a problem that the viscosity of a resin composition is excessively increased to prevent the composition from being highly expanded, and a highly-expanded micro cell structure is easily obtained.

Note that the epoxy-modified polymer can further improve the melt tension of a resin composition containing a polyester elastomer because the polymer can inhibit the cleavage of a polyester chain by hydrolysis (for example, hydrolysis resulting from moisture absorption of a raw material), thermal decomposition, oxidative decomposition, and the like, and can recombine the cleaved polyester chain. Further, since the epoxy-modified polymer has a large number of epoxy groups in a molecule, it can more easily allow a branched structure to be formed than a conventional epoxy crosslinking agent, and can further improve the degree of strain hardening of a resin composition containing a polyester elastomer.

Further, the resin composition preferably contains a lubricant. The resin composition preferably contains a lubricant because the moldability of a resin composition is improved. The resin composition preferably has improved slidability and, for example, can be preferably easily extruded from an extruder into a desired shape without clogging. Note that the lubricant may be used alone or in combination.

Examples of the lubricant include, but are not particularly limited to, aliphatic carboxylic acids and derivatives thereof (for example, aliphatic carboxylic acid anhydrides, alkali metal salts of aliphatic carboxylic acids, and alkaline earth metal salts of aliphatic carboxylic acids). Among the aliphatic carboxylic acids and derivatives thereof, especially preferred are aliphatic carboxylic acids having 3 to 30 carbon atoms such as lauryl acid and derivatives thereof, stearic acid and derivatives thereof, crotonic acid and derivatives thereof, oleic acid and derivatives thereof, maleic acid and derivatives thereof, glutaric acid and derivatives thereof, behenic acid and derivatives thereof, and montanic acid and derivatives thereof. Further, among the aliphatic carboxylic acids having 3 to 30 carbon atoms and derivatives thereof, stearic acid and derivatives thereof and montanic acid and derivatives thereof are preferred, and alkali metal salts of stearic acid and alkaline earth metal salts of stearic acid are particularly preferred, in terms of dispersibility and solubility in the resin composition and the effect of improvement in surface appearance. Furthermore, zinc stearate and calcium stearate are more suitable among alkali metal salts of stearic acid and alkaline earth metal salts of stearic acid.

In addition, the lubricant includes an acrylic lubricant. Examples of commercially available products of the acrylic lubricant include an acrylic polymer external lubricant (trade name “Metablen L”, supplied by Mitsubishi Rayon Co., Ltd.).

Particularly, an acrylic lubricant is preferred as the lubricant.

The content of the lubricant in the resin composition is preferably 0.1 to 20 parts by weight, more preferably 0.5 to 10 parts by weight, further preferably 1 to 8 parts by weight, relative to 100 parts by weight of the resin in the resin composition, but is not particularly limited thereto. The content of the lubricant is preferably not less than 0.1 parts by weight because it is easy to obtain the effect obtained by containing the lubricant. On the other hand, the content of the lubricant is preferably not more than 20 parts by weight because this suppresses the omission of cells when the resin composition is allowed to expand, and can suppress a problem that the resin composition cannot be highly expanded.

A crosslinking agent may be contained in the resin composition within the range that does not impair the effects of the present invention. Examples of the crosslinking agent include, but not limited to, an epoxy crosslinking agent, an isocyanate crosslinking agent, a silanol crosslinking agent, a melamine resin crosslinking agent, a metal salt crosslinking agent, a metal chelate crosslinking agent, and an amino resin crosslinking agent. Note that the crosslinking agent may be used alone or in combination.

The resin composition may further contain a crystallization promoter within the range which does not prevent the effects of the present invention. Examples of the crystallization promoter include, but are not particularly limited to, an olefinic resin. Preferred ones among such olefinic resins include a resin of a type having a wide molecular weight distribution with a shoulder on the high molecular weight side, a slightly crosslinked type resin (a resin of a type crosslinked a little), and a long-chain branched type resin. Examples of the olefinic resins include low density polyethylene, medium density polyethylene, high density polyethylene, linear low density polyethylene, polypropylene, a copolymer of ethylene and propylene, a copolymer of ethylene or propylene and another alpha olefin (such as butene-1, pentene-1, hexene-1, and 4-methylpentene-1), and a copolymer of ethylene and another ethylenic unsaturated monomer (such as vinyl acetate, acrylic acid, acrylate, methacrylic acid, methacrylate, and vinyl alcohol). Note that when the olefinic resin is a copolymer, the copolymer may be in either form of a random copolymer or a block copolymer. Further, the olefinic resin may be used alone or in combination.

Further, the resin composition may contain a flame retardant within the range that does not impair the effects of the present invention. This is because although the resin foam of the present invention has the characteristics of easy burning since it contains a resin, the resin foam may be used for applications in which it is indispensable to impart flame retardancy such as electric appliance or electronic appliance application. Examples of the flame retardant include, but are not particularly limited to, powder particles having flame retardancy (such as various powdery flame retardants), and preferably include inorganic flame retardants. Examples of the inorganic flame retardants may include brominated flame retardants, chlorine-based flame retardants, phosphorus flame retardants, and antimony flame retardants. However, chlorine-based flame retardants and brominated flame retardants generate a gas component which is harmful to a human body and corrosive to equipment when it burns, and phosphorus flame retardants and antimony flame retardants have problems such as harmfulness and explosibility. Therefore, non-halogen non-antimony inorganic flame retardants (inorganic flame retardants in which halogenated compounds and antimony compounds are not contained) are preferred. Examples of the non-halogen non-antimony inorganic flame retardants include hydrated metal compounds such as aluminum hydroxide, magnesium hydroxide, a magnesium oxide/nickel oxide hydrate, and a magnesium oxide/zinc oxide hydrate. Note that the hydrated metal oxides may be surface-treated. The flame retardant may be used alone or in combination.

Further, the following additives may be optionally contained in the resin composition within the range that does not impair the effects of the present invention. Examples of such additives include crystal nucleators, plasticizers, colorants (carbon black aiming at black color, pigments, and dyestuffs, and the like), ultraviolet absorbers, antioxidants, age inhibitors, reinforcements, antistatic agents, surfactants, tension modifiers, shrink resistant agents, fluidity improving agents, vulcanizing agents, surface-treating agents, dispersing aids, and polyester resin modifiers. Further, the additives may be used alone or in combination.

Particularly, the resin composition preferably contains at least the following (i) to (iv) in terms of obtaining a repulsive stress when compressed by 80% within a specific range, a maximum breaking strength within a specific range, and a strength ratio (maximum breaking strength/breaking strength in the direction orthogonal to the maximum breaking strength direction) within a specific range, thereby maintaining flexibility even under high compression and obtaining excellent assemblability.

(i): a polyester elastomer having a melt flow rate (MFR) at 230° C. of 1.5 to 4.0 g/10 min (preferably a polyester elastomer having a melt flow rate (MFR) at 230° C. of 1.5 to 4.0 g/10 min which is a block copolymer of a hard segment and a soft segment, more preferably a polyester-polyether type copolymer having a melt flow rate (MFR) at 230° C. of 1.5 to 4.0 g/10 min and containing, as a hard segment, a polyester formed by polycondensation of an aromatic dicarboxylic acid with a diol component having 2 to 4 carbon atoms between the hydroxyl groups in the main chain, and containing a polyether as a soft segment)

(ii): an epoxy-modified polymer

(iii): a lubricant (preferably an acrylic lubricant)

(iv): a foam nucleating agent (preferably a surface-treated inorganic substance, more preferably a surface-treated hard clay)

The resin composition is prepared, for example, by mixing the resin, the additives optionally added, and the like. The way to prepare the composition, however, is not limited to this. Note that heat may be applied at the time of the preparation.

The melt tension (take-up speed: 2.0 m/min) of the resin composition is preferably 15 to 70 cN, more preferably 13 to 60 cN, further preferably 15 to 55 cN, particularly preferably 26 to 50 cN, but is not particularly limited thereto. If the melt tension of the resin composition is less than 10 cN, when the resin composition is allowed to expand, the expansion ratio will be low; closed-cells will not be easily formed; and the shape of the cells formed will not be easily uniformized. On the other hand, if the melt tension of the resin composition is more than 70 cN, the fluidity may be reduced to have a bad influence on foaming.

Note that melt tension refers to a tension obtained when a molten resin extruded at a specified temperature and extrusion speed from a specified die using a specified apparatus is taken up into a strand shape at a specified take-up speed. In the present invention, the melt tension is defined as a value obtained when a resin extruded at a constant speed of 8.8 mm/min from a capillary having a diameter of 2 mm and a length of 20 mm using Capillary Extrusion Rheometer supplied from Malvern Instruments Ltd. is taken up at a take-up speed of 2 m/min.

Note that melt tension is a value measured at a temperature that is higher by 10±2° C. than the melting point of the resin in the resin composition. This is because the resin will not be in a molten state at a temperature less than the melting point; on the other hand, the resin will be in a complete liquid state at a temperature that is significantly higher than the melting point; and the melt tension cannot be measured.

The degree of strain hardening (strain rate: 0.1 [l/s]) of the resin compositions is preferably 2.0 to 5.0, more preferably 2.5 to 4.5, in terms of having a uniform and dense cell structure and suppressing rupture of cells during the expansion to obtain a highly expanded foam, but is not particularly limited thereto. Further, the degree of strain hardening of the resin composition is the degree of strain hardening at the melting point of the resin in the resin composition. Note that the degree of strain hardening is an index showing the degree of the increase in the uniaxial elongational viscosity in the measurement of the uniaxial elongational viscosity, in the region (nonlinear region) where the uniaxial elongational viscosity has risen, separated from the region (linear region) where the uniaxial elongational viscosity gradually increases with the increase in strain after starting the measurement.

The resin foam of the present invention is preferably formed by subjecting the resin composition to foam molding. A process for foaming the resin composition preferably includes, but is not limited to, a foaming process comprising impregnating a resin composition with a high-pressure gas and then subjecting the impregnated resin composition to decompression (pressure relief). That is, the resin foam of the present invention is preferably formed through the steps of impregnating the resin composition with a high-pressure gas and then subjecting the impregnated resin composition to decompression.

The gas is preferably, but not limited to, an inert gas in terms of obtaining a clean resin foam. The inert gas refers to a gas which is inert to a resin composition and with which a resin composition can be impregnated. Note that these gases may be mixed and used.

Examples of the inert gas include, but are not limited to, carbon dioxide (carbonic acid gas), nitrogen gas, helium, and air. Among these, carbon dioxide is preferred in that it can be impregnated in a large amount and at a high rate into the resin composition.

Note that the process for foaming a resin composition includes a physical foaming technique (foaming process using a physical technique) and a chemical foaming technique (foaming process using a chemical technique). If foaming is performed according to the physical technique, there may occur problems about the combustibility, toxicity, and influence on the environment such as ozone layer depletion of the substance used as a blowing agent (blowing agent gas). However, the foaming technique using an inert gas is an environmentally friendly technique in that the blowing agent as described above is not used. If foaming is performed according to the chemical technique, a residue of a blowing gas produced from the blowing agent remains in the foam. This may cause a trouble of contamination by a corrosive gas or impurities in the gas especially in electronic appliances where suppression of contamination is highly needed. However, according to the foaming technique using an inert gas, a clean foam without such impurities and the like can be obtained. In addition, the physical and chemical foaming techniques are believed to be difficult to give a micro cell structure and to be very difficult to give micro cells of not more than 300 μm.

Further, from the viewpoint of increasing the rate of impregnation into a resin composition, the gas is preferably in a supercritical state. Such gas in a supercritical state shows increased solubility in a resin composition and can be incorporated therein in a higher concentration. In addition, because of its high concentration, the supercritical gas generates a larger number of cell nuclei upon an abrupt pressure drop after impregnation. These cell nuclei grow to give cells, which are present in a higher density than in a foam having the same porosity but produced with the gas in another state. Consequently, use of a supercritical gas can give micro cells. Note that the critical temperature and critical pressure of carbon dioxide are 31° C. and 7.4 MPa, respectively.

As described above, the resin foam of the present invention is preferably produced by impregnating a resin composition with a high-pressure gas. The production may be performed by a batch system or continuous system. In the batch system, a resin composition is previously molded into an unfoamed resin molded article (unfoamed molded article) in an adequate form such as a sheet form, and then the unfoamed resin molded article is impregnated with a high-pressure gas, and the unfoamed resin molded article is then released from the pressure to allow the molded article to expand. In the continuous system, a resin composition is kneaded under a pressure together with a high-pressure gas, and the kneaded mixture is molded into a molded article and, simultaneously, is released from the pressure. Thus, molding and foaming are performed simultaneously in the continuous system.

A case where the resin foam of the present invention is produced by a batch system will be described. In the batch system, an unfoamed resin molded article is first produced when the resin foam is produced. Examples of the process for producing the unfoamed resin molded article include, but are not particularly limited to, a process in which a resin composition is extruded with an extruder such as a single-screw extruder or twin-screw extruder; a process in which a resin composition is uniformly kneaded beforehand with a kneading machine equipped with one or more blades typically of a roller, cam, kneader, or Banbury type, and the resulting mixture is press-molded typically with a hot-plate press to thereby produce an unfoamed resin molded article having a predetermined thickness; and a process in which a resin composition is molded with an injection molding machine. It is preferred to select a suitable process to give an unfoamed resin molded article having a desired shape and thickness among these processes. Note that the unfoamed resin molded article may be produced by other forming process in addition to extrusion, press molding, and injection molding. Further, with respect to the shape of the unfoamed resin molded article, various shapes are selected depending on applications, in addition to a sheet form. Examples of the shape include a sheet form, roll form, prism form, and plate form. Next, cells are formed through a gas impregnation step of putting the unfoamed resin molded article (molded article of a resin composition) in a pressure-tight vessel (high pressure vessel) and injecting (introducing) a high-pressure gas to impregnate the unfoamed resin molded article with the high-pressure gas; a decompression step of releasing the pressure (typically, to atmospheric pressure) when the unfoamed resin molded article is sufficiently impregnated with the high-pressure gas to allow cell nuclei to be generated in the unfoamed resin molded article; and optionally (where necessary) a heating step of heating the unfoamed resin molded article to allow the cell nuclei to grow. Note that the cell nuclei may be allowed to grow at room temperature without providing the heating step. After the cells are allowed to grow in this way, the unfoamed resin molded article is rapidly cooled with cold water as needed to fix its shape to yield the resin foam. Note that the introduction of the high-pressure gas may be performed continuously or discontinuously. The heating for the growth of cell nuclei can be performed according to a known or common procedure such as heating with a water bath, oil bath, hot roll, hot-air oven, far-infrared rays, near-infrared rays, or microwaves.

That is, the resin foam of the present invention may be formed by allowing it to expand through the steps of impregnating the unfoamed molded article comprising the resin composition with a high-pressure gas and then subjecting the impregnated unfoamed molded article to decompression. Further, the resin foam of the present invention may be formed through the steps of impregnating the unfoamed molded article comprising the resin composition with a high-pressure gas and then subjecting the impregnated unfoamed molded article to decompression, followed by heating the decompressed molded article.

On the other hand, examples of the case where the resin foam is produced by a continuous system include the production by a kneading/impregnation step of kneading a resin composition with an extruder such as a single-screw extruder or twin-screw extruder and, during this kneading, injecting (introducing) a high-pressure gas to impregnate a resin composition with the gas sufficiently; and a subsequent molding/decompression step of extruding a resin composition through a die arranged at a distal end of the extruder to thereby release the pressure (typically, to atmospheric pressure) to perform molding and foaming simultaneously. Optionally (where necessary), a heating step may be further provided to enhance cell growth by heating. After the cells are allowed to grow in this way, the resin composition is rapidly cooled with cold water as needed to fix its shape to yield the resin foam. Note that, in the kneading/impregnation step and molding/decompression step, an injection molding machine or the like may be used in addition to an extruder.

That is, the resin foam of the present invention may be formed by allowing it to expand through the steps of impregnating a molten resin composition with a high-pressure gas and then subjecting the impregnated resin composition to decompression. Further, the resin foam of the present invention may be formed through the steps of impregnating the molten resin composition with a high-pressure gas and then subjecting the impregnated resin composition to decompression, followed by heating the decompressed resin composition.

In the gas impregnation step in the batch system or in the kneading/impregnation system in the continuous system, the amount of the gas to be incorporated into the resin composition is not particularly limited, for example, the amount is preferably 2 to 10% by weight, more preferably 2 to 6% by weight, relative to the total amount of the resin composition.

In the gas impregnation step in the batch system or in the kneading/impregnation step in the continuous system, the pressure at which the unfoamed resin molded article or a resin composition is impregnated with a gas is preferably not less than 3 MPa (for example, 3 to 100 MPa), more preferably not less than 4 MPa (for example, 4 to 100 MPa). If the pressure of the gas is lower than 3 MPa, considerable cell growth may occur during foaming, and this may tend to result in too large cell diameters and hence in disadvantages such as insufficient dustproofing effect. Therefore, the pressure of the gas lower than 3 MPa is not preferred. The reasons for this are as follows. When impregnation is performed at a low pressure, the amount of gas impregnated is relatively small and cell nuclei are formed at a lower rate as compared with impregnation at higher pressures. As a result, the number of cell nuclei formed is smaller. Because of this, the gas amount per cell increases rather than decreases, resulting in excessively large cell diameters. Furthermore, in a region of pressures lower than 3 MPa, only a slight change in impregnation pressure results in considerable changes in cell diameter and cell density, and this may often impede the control of cell diameter and cell density.

Further, in the gas impregnation step in the batch system or in the kneading/impregnation system in the continuous system, the temperature at which the unfoamed resin molded article or a polyester elastomer composition is impregnated with a high-pressure gas can be selected within a wide range. When impregnation operability and other conditions are taken into account, the impregnation temperature is preferably 10° C. to 350° C. For example, when an unfoamed resin molded article in a sheet form is impregnated with a high-pressure gas in the batch system, the impregnating temperature is preferably 40 to 300° C., more preferably 100 to 250° C. Further, when a high-pressure gas is injected into and kneaded with a resin composition in the continuous system, the impregnation temperature is preferably 150 to 300° C., more preferably 210 to 250° C. Note that when carbon dioxide is used as a high-pressure gas, it is preferred to impregnate the gas at a temperature (impregnation temperature) of 32° C. or higher (particularly 40° C. or higher), in order to maintain its supercritical state.

Note that, in the decompression step, the decompression rate is preferably 5 to 300 MPa/s in order to obtain uniform micro cells, but is not particularly limited thereto. Further, the heating temperature in the heating step is preferably 40 to 250° C., more preferably 60 to 250° C., but is not particularly limited thereto.

Further, a resin foam having a high expansion ratio can be produced according to the process for producing the resin foam, and therefore, a thick resin foam can be obtained. For example, when the resin foam is produced by the continuous system, it is necessary to regulate the gap in the die at the tip of the extruder so as to be as narrow as possible (generally 0.1 to 1.0 mm) for maintaining the pressure in the extruder in the kneading/impregnation step. This means that for obtaining a thick resin foam, a resin composition which has been extruded through such narrow gap should be foamed at a high expansion ratio. In the known techniques in use, however, a high expansion ratio is not obtained and the resulting foam has been limited to thin one (for example, one having a thickness of 0.5 to 2.0 mm). In contrast, the process for producing the resin foam using a high-pressure gas can continuously produce a resin foam having a final thickness of 0.30 to 5.00 mm.

Since the resin foam of the present invention has a repulsive stress when compressed by 80% within a specific range, the resin foam is excellent in flexibility. In particular, the resin foam is excellent in flexibility even under high compression. Further, since the resin foam is excellent in flexibility, the resin foam can follow a fine clearance (for example, a level difference of 0.1 mm). Note that since the resin foam of the present invention is excellent in flexibility even under high compression, when the resin foam is attached to electric or electronic appliances, deformation of a housing, deformation of a display, and occurrence of appearance defects can be effectively suppressed.

Further, since the resin foam of the present invention has a maximum breaking strength within a specific range and a strength ratio (maximum breaking strength/breaking strength in the direction orthogonal to the maximum breaking strength direction) within a specific range, the resin foam is excellent in isotropy of strength, and plastic deformation, tearing, and breakage during assembly and processing can be effectively suppressed. Therefore, the resin foam of the present invention is excellent in assemblability. Further, the resin foam of the present invention is excellent in processability. Note that a resin foam may be poor in isotropy of strength even if the resin foam has a high strength, and when the anisotropy of strength is high, the resin foam will be easily cut.

Particularly, since the resin foam of the present invention has the above characteristics, when the resin foam is assembled to a portion having a small space, the tearing, cutting, variation of elongation, plastic deformation, and the like can be suppressed even if the resin foam is elongated by applying tension to reduce the width of the resin foam so as to be adapted to the size of the space. Therefore, the resin foam of the present invention can be easily assembled according to a desired size.

Since the resin foam of the present invention has the above characteristics, it is suitably used as a sealing material and a dustproofing material for electric appliances, electronic appliances, or the like. Further, it is suitably used as a cushioning material and a shock absorber, particularly as a cushioning material and a shock absorber for electric appliances or electronic appliances.

### (Foam Material)

The resin foam of the present invention may be used as a foam material. That is, the foam material is a material comprising the resin foam of the present invention. The foam material may have a structure consisting only of the resin foam of the present invention, or may have a structure in which other layers (particularly, a pressure-sensitive adhesive layer (adhesive layer), a base material layer, and the like) are laminated to the resin foam.

The shape of the foam material is preferably a sheet form (including a film form) and a tape form, but is not particularly limited thereto. The foam material may be processed so as to have desired shape, thickness, and the like. For example, it may be processed to various shapes according to the apparatus, equipment, housing, member, and the like in which it is used.

In particular, the foam material preferably has a pressure-sensitive adhesive layer. For example, when the foam material is a foam material in a sheet form, it preferably has a pressure-sensitive adhesive layer on one side or both sides thereof. When the foam material has a pressure-sensitive adhesive layer, a mount for processing, for example, can be provided on the foam material through the pressure-sensitive adhesive layer, and the foam material can also be fixed or tentatively fixed to an object (for example, a housing, a part, or the like).

Examples of the pressure-sensitive adhesives for forming the pressure-sensitive adhesive layer include, but are not limited to, acrylic pressure-sensitive adhesives, rubber pressure-sensitive adhesives (such as natural rubber pressure-sensitive adhesives and synthetic rubber pressure-sensitive adhesives), silicone pressure-sensitive adhesives, polyester pressure-sensitive adhesives, urethane pressure-sensitive adhesives, polyamide pressure-sensitive adhesives, epoxy pressure-sensitive sensitive adhesives, vinyl alkyl ether pressure-sensitive adhesives, and fluorine pressure-sensitive adhesives. The pressure-sensitive adhesives may be used alone or in combination. Further, the pressure-sensitive adhesives may be pressure-sensitive adhesives of any form including emulsion pressure-sensitive adhesives, solvent pressure-sensitive adhesives, hot melt type adhesives, oligomer pressure-sensitive adhesives, and solid pressure-sensitive adhesives. Especially, acrylic pressure-sensitive adhesives are preferred as the pressure-sensitive adhesives from the point of view of the pollution control to adherends and the like. That is, the foam material preferably has an acrylic pressure-sensitive adhesive layer on the resin foam of the present inventions.

The thickness of the pressure-sensitive adhesive layer is preferably 2 to 100 μm, more preferably 10 to 100 μm, but is not particularly limited thereto. The pressure-sensitive adhesive layer is preferably as thin as possible because a thinner layer has a higher effect of preventing adhesion of soil and dust at an end. Note that the pressure-sensitive adhesive layer may have any form of a single layer and a laminate.

In the foam material, the pressure-sensitive adhesive layer may be provided through other layers (lower layers). Examples of such lower layers include other pressure-sensitive adhesive layers, an intermediate layer, an undercoat layer, and a base material layer (particularly a film layer, a nonwoven fabric layer, and the like). Further, the pressure-sensitive adhesive layer may be protected by a release film (separator) (such as a releasing paper and a release film).

Since the foam material comprises the resin foam of the present invention, the foam material is excellent in assemblability. Further, the foam material is excellent in flexibility and excellent in compressibility even under high compression. The foam material has a flexibility that can follow fine clearance. Furthermore, the foam material is excellent also in processability.

Since the foam material has the characteristics as described above, it is suitably used as a material used for attaching (mounting) various members or parts to a predetermined site. In particular, the foam material is suitably used as a material used for attaching (mounting) parts constituting electric or electronic appliances to a predetermined site. Further, since the foam material is excellent in flexibility even under high compression, when the foam material is attached to electric or electronic appliances, deformation of a housing, deformation of a display, and occurrence of appearance defects can be effectively suppressed.

That is, the foam material is suitably used for electric or electronic appliances. That is, the foam material may be a foam material for electric or electronic appliances.

Examples of the various members or parts which can be attached (mounted) utilizing the foam material preferably include, but are not particularly limited to, various members or parts in electric or electronic appliances. Examples of such members or parts for electric or electronic appliances include optical members or optical components such as image display members (displays) (particularly small-sized image display members) which are mounted on image display devices such as liquid crystal displays, electroluminescence displays, and plasma displays, and cameras and lenses (particularly small-sized cameras and lenses) which are mounted on mobile communication devices such as so-called “cellular phones” and “personal digital assistants”.

Examples of suitable use modes of the foam material of the present invention include using it around a display such as LCD (liquid crystal display) and using by inserting it between a display such as LCD (liquid crystal display) and a housing (window part) for the purpose of dustproofing, shading, cushioning, or the like.

Hereinafter, the present invention will be more specifically described with reference to Examples and Comparative Examples. However, the present invention is not at all limited thereto.

### EXAMPLE 1

In a twin-screw kneader were kneaded, at a temperature of 220° C., 100 parts by weight of a block copolymer of polybutylene terephthalate as a hard segment and polyether as a soft segment (trade name “Hytrel 5577” supplied by Du Pont-Toray Co., Ltd., melt flow rate at 230° C.: 1.8 g/10 min, melting point: 208° C.), 5 parts by weight of an acrylic lubricant (trade name “Metablen L-1000” supplied by Mitsubishi Rayon Co., Ltd.), 1 part by weight of hard clay surface-treated with a silane coupling agent (trade name “ST-301” supplied by Shiraishi Calcium Kaisha, Ltd.), 5 parts by weight of carbon black (trade name “Asahi #35” supplied by Asahi Carbon Co., Ltd.), and 2 parts by weight of an epoxy modifier (epoxy-modified acrylic polymer, weight average molecular weight (Mw): 50000, epoxy equivalent: 1200 g/eq, viscosity: 2850 mPa·s). The kneaded mixture was then extruded into strands, cooled with water, and formed into pellets by cutting. The pellets were charged into a single-screw extruder, and carbon dioxide gas was injected at an atmospheric temperature of 240° C. and at a pressure of 17 MPa, where the pressure became 13 MPa after injection. The pellets were sufficiently saturated with the carbon dioxide gas, cooled to a temperature suitable for foaming, and extruded through a die, yielding a polyester elastomer foam in a sheet form having a thickness of 2.0 mm.

### EXAMPLE 2

In a twin-screw kneader were kneaded, at a temperature of 220° C., 100 parts by weight of a block copolymer of polybutylene terephthalate as a hard segment and polyether as a soft segment (trade name “PELPRENE P-90BD” supplied by Toyobo Co., Ltd., melt flow rate at 230° C.: 3.0 g/10 min, melting point: 204° C.), 5 parts by weight of an acrylic lubricant (trade name “Metablen L-1000” supplied by Mitsubishi Rayon Co., Ltd.), 1 part by weight of hard clay surface-treated with a silane coupling agent (trade name “ST-301” supplied by Shiraishi Calcium Kaisha, Ltd.), 5 parts by weight of carbon black (trade name “Asahi #35” supplied by Asahi Carbon Co., Ltd.), and 2 parts by weight of an epoxy modifier (epoxy-modified acrylic polymer, weight average molecular weight (Mw): 50000, epoxy equivalent: 1200 g/eq, viscosity: 2850 mPa·s). The kneaded mixture was then extruded into strands, cooled with water, and formed into pellets by cutting. The pellets were charged into a single-screw extruder, and carbon dioxide gas was injected at an atmospheric temperature of 240° C. and at a pressure of 17 MPa, where the pressure became 13 MPa after injection. The pellets were sufficiently saturated with the carbon dioxide gas, cooled to a temperature suitable for foaming, and extruded through a die, yielding a polyester elastomer foam in a sheet form having a thickness of 2.0 mm.

### EXAMPLE 3

In a twin-screw kneader were kneaded, at a temperature of 220° C., 100 parts by weight of a block copolymer of polybutylene terephthalate as a hard segment and polyether as a soft segment (trade name “PELPRENE P-90BD” supplied by Toyobo Co., Ltd., melt flow rate at 230° C.: 3.0 g/10 min, melting point: 204° C.), 5 parts by weight of an acrylic lubricant (trade name “Metablen L-1000” supplied by Mitsubishi Rayon Co., Ltd.), 3 parts by weight of hard clay surface-treated with a silane coupling agent (trade name “ST-301” supplied by Shiraishi Calcium Kaisha, Ltd.), 5 parts by weight of carbon black (trade name “Asahi #35” supplied by Asahi Carbon Co., Ltd.), and 2 parts by weight of an epoxy modifier (epoxy-modified acrylic polymer, weight average molecular weight (Mw): 50000, epoxy equivalent: 1200 g/eq, viscosity: 2850 mPa·s). The kneaded mixture was then extruded into strands, cooled with water, and formed into pellets by cutting. The pellets were charged into a single-screw extruder, and carbon dioxide gas was injected at an atmospheric temperature of 240° C. and at a pressure of 17 MPa, where the pressure became 13 MPa after injection. The pellets were sufficiently saturated with the carbon dioxide gas, cooled to a temperature suitable for foaming, and extruded through a die, yielding a polyester elastomer foam in a sheet form having a thickness of 2.0 mm.

### COMPARATIVE EXAMPLE 1

Into a single-screw extruder were charged 35 parts by weight of polypropylene (melt flow rate (MFR): 0.35 g/10 min), 60 parts by weight of a polyolefin elastomer (melt flow rate (MFR): 6 g/10 min, JIS A hardness: 79°), 10 parts by weight of magnesium hydroxide, and 10 parts by weight of carbon (trade name “Asahi #35” supplied by Asahi Carbon Co., Ltd.). Carbon dioxide gas was injected at an atmospheric temperature of 220° C. and at a pressure of 13 MPa, where the pressure became 12 MPa after injection. The mixture was sufficiently saturated with the carbon dioxide gas, cooled to a temperature suitable for foaming, and extruded through a die, yielding a polyolefin elastomer foam in a sheet form having a thickness of 2.1 mm.

### COMPARATIVE EXAMPLE 2

In a twin-screw kneader were kneaded, at a temperature of 220° C., 100 parts by weight of a block copolymer of polybutylene terephthalate as a hard segment and polyether as a soft segment (trade name “Hytrel 5577” supplied by Du Pont-Toray Co., Ltd., melt flow rate at 230° C.: 1.8 g/10 min), 5 parts by weight of an acrylic lubricant (trade name “Metablen L-1000” supplied by Mitsubishi Rayon Co., Ltd.), 1 part by weight of polypropylene (trade name “NEWSTREN SH9000” supplied by Japan Polypropylene Corporation), and 1 part by weight of magnesium hydroxide. The kneaded mixture was then extruded into strands, cooled with water, and formed into pellets by cutting. The pellets were charged into a single-screw extruder, and carbon dioxide gas was injected at an atmospheric temperature of 240° C. and at a pressure of 17 MPa, where the pressure became 13 MPa after injection. The pellets were sufficiently saturated with the carbon dioxide gas, cooled to a temperature suitable for foaming, and extruded through a die, yielding a polyester elastomer foam in a sheet form having a thickness of 2.5 mm.

### COMPARATIVE EXAMPLE 3

In a twin-screw kneader were kneaded, at a temperature of 220° C., 100 parts by weight of a block copolymer of polybutylene terephthalate as a hard segment and polyether as a soft segment (trade name “Hytrel 5577” supplied by Du Pont-Toray Co., Ltd., melt flow rate at 230° C.: 1.8 g/10 min, melting point: 208° C.), 5 parts by weight of an acrylic lubricant (trade name “Metablen L-1000” supplied by Mitsubishi Rayon Co., Ltd.), 1 part by weight of polypropylene (trade name “NEWSTREN SH9000” supplied by Japan Polypropylene Corporation), 1 part by weight of magnesium hydroxide, 5 parts by weight of carbon black (trade name “Asahi #35” supplied by Asahi Carbon Co., Ltd.), and 0.5 parts by weight of an epoxy crosslinking agent (trifunctional epoxy compound, trade name “TEPIC-G” supplied by Nissan Chemical Industries, Ltd., melting point: 90 to 125° C., epoxy equivalent: 110 g/eq, viscosity: not more than 100 cp, molecular weight: 297). The kneaded mixture was then extruded into strands, cooled with water, and formed into pellets by cutting. The pellets were charged into a single-screw extruder, and carbon dioxide gas was injected at an atmospheric temperature of 240° C. and at a pressure of 17 MPa, where the pressure became 13 MPa after injection. The pellets were sufficiently saturated with the carbon dioxide gas, cooled to a temperature suitable for foaming, and extruded through a die, yielding a polyester elastomer foam in a sheet form having a thickness of 2.2 mm.

### COMPARATIVE EXAMPLE 4

There was used a commercially available foam essentially comprising polyurethane having an average cell diameter of 160 μm, a repulsive stress when compressed by 80% of 9.5 N/cm², and an apparent density of 0.15 g/cm³.

The foam was in a sheet form and had a thickness of 1.0 mm. Further, the repulsive stress at 50% compression (50% repulsive load) was 0.7 N/cm².

### (Evaluation)

Foams from Examples and Comparative Example were subjected to the following measurements or evaluations. Then, the results are shown in Table 1.

### (Apparent Density)

A foam was punched into a test piece in a sheet form with a punching blade die having a size of 30 mm in width and 30 mm in length. The dimension of the test piece was measured with a vernier caliper. Further, the thickness of the test piece was measured with a 1/100 dial gauge having a measuring terminal of 20 mm in diameter ((φ). The volume of the test piece was calculated from these values. Next, the weight of the test piece was measured with an electronic balance. From the volume of the test piece and the weight of the test piece, the apparent density (g/cm³) of the foam was calculated by the following formula.

Apparent density of foam (g/cm³)=(weight of test piece)/(volume of test piece)

### (Average Cell Diameter)

An enlarged image of a foam cell portion was captured using a digital microscope (trade name “VHX-500” supplied by Keyence Corporation), and the area of all the cells appeared in a definite area (1 mm²) of a cut surface was measured by analyzing the image using the image analysis software (trade name “Win ROOF” supplied by Mitani Corporation) of the digital microscope. Then, the area was converted to the equivalent circle diameter and then averaged with the number of cells to determine the average cell diameter (μm).

(Repulsive Stress when Compressed by 80% (Repulsive Force at 80% Compression, Repulsive Load at 80% Compression, 80% Compressive Load))

The repulsive stress at 80% compression was measured according to the method for measuring a compressive hardness prescribed in JIS K 6767.

A foam was cut into a test piece in a sheet form having a size of 30 mm in width and 30 mm in length. Next, the test piece was compressed in the thickness direction at a rate of compression of 10 mm/min until the test piece was compressed to a compression ratio of 80% to determine the stress (N), which was converted to a value per unit area (1 cm²) to obtain a repulsive force (N/cm²).

### (Ratio of Maximum Breaking Strength to Breaking Strength in the Direction Orthogonal to the Direction of Maximum Breaking Strength)

A test piece in a sheet form having a thickness of 0.5 mm, a width of 30 mm, and a length of 30 mm was obtained from a foam. The test piece was measured for a breaking strength in a longitudinal direction in the horizontal direction of the test piece; further, the longitudinal direction was rotated about an axis by 10° intervals to measure a breaking strength in each direction. Measurement of a breaking strength was performed in 18 directions. Note that the 18 directions in which the foam was measured for a breaking strength are shown in FIG. 1.

Note that a breaking strength was measured based on the section of tensile strength and elongation in JIS K 6767.

Next, a direction where the highest breaking strength was measured was defined as a maximum breaking strength direction, and a breaking strength in the maximum breaking strength direction was defined as a maximum breaking strength (MPa). Further, a breaking strength (MPa) in a direction orthogonal to the maximum breaking strength direction was determined.

Then, a “ratio of the maximum breaking strength to the breaking strength in the direction orthogonal to the maximum breaking strength direction (strength ratio (maximum breaking strength/breaking strength in the direction orthogonal to the maximum breaking strength direction)) was determined from the maximum breaking strength and the breaking strength in the direction orthogonal to the maximum breaking strength direction.

### (Assemblability)

A foam was cut in 10 arbitrary directions in the horizontal direction of the foam to obtain 10 test pieces in a sheet form having a thickness of 0.5 mm, a width of 3 mm, and a length of 30 cm.

Next, the test piece was assembled to a housing while applying tension in the longitudinal direction of the test piece using a load of 1.0 N, in the state where one end in the longitudinal direction of the test piece was fixed. At this time, the length of the test piece after assembly was measured, and when the length was in the range of 30.0 to 31.0 cm, the test piece was rated as acceptable, and when the length was more than 31.0 cm (that is, when the test piece was greatly elongated) or when the test piece was cut during assembly, the test piece was rated as unacceptable.

When all of the 10 test pieces were “acceptable”, the assemblability was evaluated as “good”; on the other hand, when at least one “unacceptable” was included, the assemblability was evaluated as “poor.”

### (Housing Deformability)

A foam was cut to obtain a test piece (test piece 21) having a width of 50 mm, a length of 50 mm, and a thickness of 1.0 mm.

The test piece was set as shown in FIG. 2 in a jig (square, jig 2) as shown in FIG. 2; the test piece was compressed in the thickness direction with an acrylic sheet (acrylic sheet 22a having a thickness of 1 mm) on the top surface side; and the state of deformation of the acrylic sheet (acrylic sheet 22a) on the top surface side was observed with a microscope.

Specifically, spacers having a thickness of 0.4 mm (spacers 23 having a thickness of 0.4 mm) were placed on both end parts of the acrylic sheet having a thickness of 2 mm (acrylic sheet 22b having a thickness of 2 mm); the test piece (test piece 21) was placed in the central part between the spacers; and an acrylic sheet having a thickness of 1 mm (acrylic sheet 22a having a thickness of 1 mm) was placed on the top surface of the test piece. Then, at the positions corresponding to the spacers on both the end parts, bolts were diagonally fastened to the jig at four points from the side of the acrylic sheet (acrylic sheet 22a having a thickness of 1 mm) on the top surface side to uniformly apply a force in the thickness direction of the test piece to compress the test piece in the thickness direction. At this time, the presence or absence of deformation of the acrylic sheet (acrylic sheet 22a having a thickness of 1 mm) on the top surface side was observed with a microscope. Then, when deformation was not observed, housing deformability was evaluated as “no”, and when deformation was observed, housing deformability was evaluated as “yes.”

### (Melt Tension)

Capillary Extrusion Rheometer supplied by Malvern Instruments Ltd. was used for the measurement of melt tension, and a tension when a resin extruded at a constant speed of 8.8 mm/min from a capillary having a diameter of 2 mm and a length of 20 mm was taken up at a take-up speed of 2 m/min was defined as melt tension.

Note that pellets before foam molding were used for measurement. In addition, the temperature at the measurement was a temperature that was higher by 10±2° C. than the melting point of the resin.

### (Degree of Strain Hardening)

Pellets before foam molding were used for the measurement. The pellets were formed into a sheet form having a thickness of 1 mm using a heated hot plate press, thus obtaining a sheet. A sample (10 mm in length, 10 mm in width, 1 mm in thickness) was cut from the sheet.

Using the sample, the uniaxial elongational viscosity at a strain rate of 0.1 [l/s] was measured using a uniaxial elongational viscometer (supplied by TA Instruments Corp.). Then, the degree of strain hardening was determined by the following formula.

Degree of strain hardening=log ηmax/log η0.2

(ηmax shows the highest elongational viscosity in the measurement of the uniaxial elongational viscosity, and η0.2 shows the elongational viscosity at a strain ε of 0.2.)

Note that the temperature at the measurement was the melting point of the resin.

### [Table 1]

TABLE 1

| | | | | Comparative | Comparative | Comparative | Comparative |
|---|---|---|---|---|---|---|---|
| | Example 1 | Example 2 | Example 3 | Example 1 | Example 2 | Example 3 | Example 4 |
| Density (g/cm³) | 0.070 | 0.070 | 0.090 | 0.055 | 0.080 | 0.085 | 0.15 |
| Average cell diameter (μm) | 80 | 70 | 80 | 80 | 80 | 100 | 160 |
| Repulsive stress when | 6.5 | 6.0 | 8.0 | 3.9 | 6.7 | 8.3 | 9.5 |
| compressed by 80% (N/cm²) | | | | | | | |
| Maximum breaking strength | 1.64 | 1.56 | 1.78 | 0.86 | 1.30 | 1.17 | 0.10 |
| (MPa) | | | | | | | |
| Breaking strength in the | 0.95 | 0.99 | 1.01 | 0.35 | 0.23 | 0.08 | 0.09 |
| direction orthogonal to | | | | | | | |
| maximum breaking strength | | | | | | | |
| direction (MPa) | | | | | | | |
| Strength ratio | 1.73 | 1.58 | 1.74 | 2.45 | 5.52 | 15.3 | 1.11 |
| Assemblability | good | good | good | poor | poor | poor | poor |
| Housing deformability | no | no | no | no | no | yes | yes |
| Color | black | black | black | black | white | black | black |
| Melt tension (cN) | 18 | 27 | 29 | — | — | 16 | — |
| Degree of strain hardening | 3.66 | 4.12 | 3.01 | — | — | 1.69 | — |

Note that the “strength ratio” in Table 1 shows a “ratio of the maximum breaking strength to the breaking strength in the direction orthogonal to the maximum breaking strength direction (strength ratio (maximum breaking strength/breaking strength in the direction orthogonal to the maximum breaking strength direction)).”

As apparent from Table 1, the resin foams of Examples have a small repulsive load (repulsive stress) under high compression, have a high maximum breaking strength although they are flexible, and are excellent in isotropy because they have a small strength ratio (maximum breaking strength/breaking strength in the direction orthogonal to the maximum breaking strength direction). Therefore, the resin foams have excellent workability without being elongated or being torn during attachment. Furthermore, assembly and lamination to size can be performed with excellent workability during assembly.

### INDUSTRIAL APPLICABILITY

The resin foam and the foam material of the present invention can be used for electric or electronic appliances (for example, cellular phones, personal digital assistants, smart phones, tablet computers (tablet PC), digital cameras, digital video cameras, video cameras, personal computers, and household electrical appliances).

### REFERENCE SIGNS LIST

1 Foam (foam in a sheet form)
   A Longitudinal direction
   B Width direction
   C Direction for measuring breaking strength
2 Jig
   21 Foam
   22a Acrylic sheet
   22b Acrylic sheet
   23 Spacer

1. A resin foam having a repulsive stress when compressed by 80% of 1.0 to 9.0 N/cm2, a maximum breaking strength as defined below of 1.0 to 10.0 MPa, and a ratio of the maximum breaking strength as defined below to a breaking strength in a direction orthogonal to a maximum breaking strength direction (maximum breaking strength/breaking strength in the direction orthogonal to the maximum breaking strength direction) of 1.0 to 5.0,
wherein the maximum breaking strength is defined as follows: a resin foam in a sheet form is measured for a breaking strength in an arbitrary direction in a horizontal direction of the sheet; next, the arbitrary direction is rotated about an axis by 10° intervals to measure a breaking strength in each direction; a direction where the highest breaking strength is measured is defined as the maximum breaking strength direction; and a breaking strength in the maximum breaking strength direction is defined as the maximum breaking strength.

2. The resin foam according to claim 1, wherein the resin foam has an average cell diameter of 10 to 200 μm and an apparent density of 0.01 to 0.20 g/cm3.

3. The resin foam according to claim 1, wherein a resin constituting the resin foam is a thermoplastic resin.

4. The resin foam according to claim 3, wherein the thermoplastic resin is polyester.

5. The resin foam according to claim 1, wherein the resin foam is formed through the steps of impregnating the resin composition with a high-pressure gas and then subjecting the impregnated resin composition to decompression.

6. The resin foam according to claim 5, wherein the gas is an inert gas.

7. The resin foam according to claim 6, wherein the gas is carbon dioxide gas.

8. The resin foam according to claim 5, wherein the high-pressure gas is a gas in a supercritical state.

9. A foam material comprising a resin foam according to claim 1.

10. The foam material according to claim 9, wherein the foam material has a pressure-sensitive adhesive layer on the resin foam.

11. The foam material according to claim 10, wherein the pressure-sensitive adhesive layer is an acrylic pressure-sensitive adhesive layer.
